(19) United States
(12) Patent Application Publication
(10) Pub. No.: US 2026/0249175 A1
(43) Pub. Date: Aug. 27, 2026

(54) SYSTEM AND METHOD OF STREAMING CONTENT

(71) Applicant: Sony Interactive Entertainment Europe Ltd., London (GB)

(72) Inventor: Marcos CONDE, London (GB)

(73) Assignee: Sony Interactive Entertainment Europe Ltd., London (GB)

(21) Appl. No.: 19/549,428

(22) Filed: Feb. 25, 2026

(30) Foreign Application Priority Data
Feb. 25, 2025 (GB) 2502724.4

(51) Int. Cl. A63F 13/355; A63F 13/52; G06F 3/01; G06T 15/10

(52) U.S. Cl. CPC A63F 13/355; A63F 13/52; G06F 3/012; G06T 15/10

(57) ABSTRACT

A method of content streaming comprises the steps of receiving, for a given camera location in an environment, at a client device a neural representation ‘NR’ corresponding to a region of the environment encompassing that camera location, the NR having been trained to generate images of viewpoints within the corresponding region; repeatedly inputting a current camera location to the NR, whilst the current camera location remains within the region of the environment that the NR corresponds to, causing it to output a corresponding image of the corresponding region at the current camera location; and providing the output image to a display process.

### CROSS-REFERENCE TO RELATED APPLICATIONS

This application claims the benefit of and priority to UK Patent Application No. 2502724.4, filed on Feb. 25, 2025, the disclosure of which is herein incorporated by reference in its entirety for all purposes.

### FIELD

The present invention relates to a system and method of streaming content.

### BACKGROUND

Streaming typically requires obtaining a source image at a server, encoding that image, and transmitting it over a network such as the internet to a client device, which decodes the image and outputs it for display. This is typically done repeatedly (e.g. 30, 50, or 60 times per second) to provide a video stream.

Viewing content downstream may be sensitive to variability in latency, causing image frames to complete at different intervals, but this can be addressed by using a buffer to accumulate completed frames before displaying them at a regular rate.

However, for interactive streaming such as in videogames a buffer is undesirable, as the time lag between a user's input and a corresponding displayed effect is ideally as small as possible. The buffer introduces multiple frames of lag.

Hence for interactive streaming both latency per se and also latency variability are issues that typically need to be addressed within the streaming process rather than mitigated by other means.

The present invention seeks to address or mitigate such issues.

### SUMMARY

Various aspects and features of the present invention are defined in the appended claims and within the text of the accompanying description.

Some embodiments include a method that includes: receiving, for a given camera location in an environment and at a client device, a neural representation (NR) corresponding to a region of the environment encompassing the given camera location, the NR having been trained to generate images of viewpoints within the corresponding region; inputting and repeatedly updating a current camera location to the NR, while the current camera location remains within the region of the environment that the NR corresponds to, causing it to output a corresponding image of the corresponding region at the current camera location; and providing the output image to a display process.

In some embodiments, the method further includes: repeatedly inputting a current camera location, the current camera location comprising an input of a current camera orientation.

In some embodiments, the environment comprises a plurality of regions, wherein a respective trained NR is associated with each region of the plurality of regions, and the method further includes: receiving the respective trained NR for a region adjacent to a boundary if a current camera location nears a region boundary.

In some embodiments, the respective trained NR is trained on a predetermined sampling of viewpoints within a respective region.

In some embodiments, the respective trained NR is trained on images captured during gameplay within a respective region.

In some embodiments, transient elements within the environment are omitted from generating the respective trained NR.

In some embodiments, the respective trained NR is trained on a predetermined supplemental sampling of viewpoints for parts of the region not trained using images captured during gameplay.

In some embodiments, the method further includes: receiving a control input; and obtaining an updated current camera location by: updating the current camera location at the client device in response to the control input; requesting an update from a remote server, the request comprising information about the control input, and receiving the updated current camera location from the remote server; or combination thereof.

In some embodiments, the method further including: streaming dynamic image elements for the output image to the client device; and compositing the output image and the dynamic image elements to produce a composite image, and wherein providing the output image to a display process comprises providing the composite image to a display process.

In some embodiments, the method further including: receiving at the client device a further NR corresponding to the region, the further NR having been trained on an artificially constructed environment separate to a game environment comprising views of one or more dynamic image elements in one or more states; obtaining a desired dynamic image element in a desired state by inputting to the NR a location corresponding to the views within the artificially constructed environment of the desired dynamic image element in the desired state, causing the NR to generate an image of the desired dynamic image element in the desired state; compositing the output image of the region at the current camera location and the image of the desired dynamic image element in the desired state to produce a composite image; and providing the output image to a display process comprises providing the composite image to a display process.

In some embodiments, the method further including: identifying when the client device is a head mounted display ‘HMD’; generating image data using the NR in response to a current user viewpoint, at a generation rate higher than a frame rate of streamed image data; and replacing some or all of the streamed image data if a current user viewpoint has changed by more than a threshold amount from a viewpoint represented by the streamed image data as it is to be displayed to the user.

In some embodiments, the method further including: selecting the neural representation identified as a selection of a single neural representation from a set comprising: a neural radiance field; a Gaussian splatting; and a neural network that compresses 3D information.

Some embodiments include a system that includes: one or more processors; and one or more computer-readable media storing instructions which, when executed by the one or more processors, cause the system to perform part or all of the operations and/or methods disclosed herein.

Some embodiments include one or more non-transitory computer-readable media storing instructions which, when executed by one or more processors, cause a system to perform part or all of the operations and/or methods disclosed herein.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is a schematic diagram of an entertainment device in accordance with embodiments of the present description.

FIG. 2 is a flow diagram of a method of content streaming in accordance with embodiments of the present description.

### DESCRIPTION OF THE EMBODIMENTS

A system and method of streaming content are disclosed. In the following description, a number of specific details are presented in order to provide a thorough understanding of the embodiments of the present invention. It will be apparent, however, to a person skilled in the art that these specific details need not be employed to practice the present invention. Conversely, specific details known to the person skilled in the art are omitted for the purposes of clarity where appropriate.

### Hardware

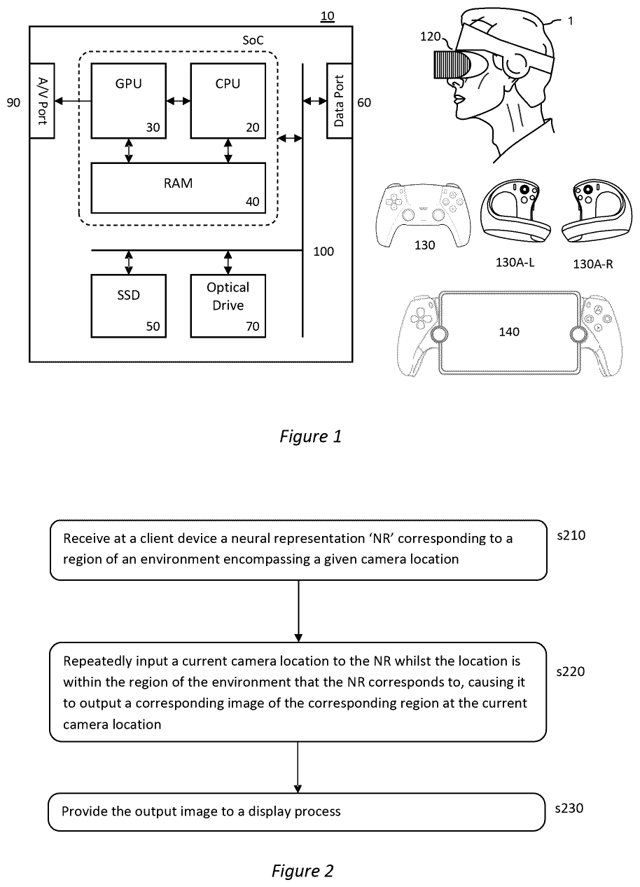

Referring now to the drawings, wherein like reference numerals designate identical or corresponding parts throughout the several views, FIG. 1 shows an example of an entertainment system 10 such as computer or console. The entertainment system 10 may be considered an example of a server device or a client device as appropriate herein.

The entertainment system 10 comprises a central processor or CPU 20. The entertainment system also comprises a graphical processing unit or GPU 30, and RAM 40. Two or more of the CPU, GPU, and RAM may be integrated as a system on a chip (SoC). Further storage may be provided by a disk 50.

The entertainment device may transmit or receive data via one or more data ports 60. It may also optionally receive data via an optical drive 70. Audio/visual outputs from the entertainment device are typically provided through one or more A/V ports 90 or one or more of the data ports 60. Where components are not integrated, they may be connected as appropriate either by a dedicated data link or via a bus 100.

Examples of a device for displaying images output by the entertainment system include a head mounted display ‘HMD’ 120 worn by a user 1, a TV (not shown), and a portable screen 140.

Interaction with the system (e.g. when operating as a client device) is typically provided using one or more handheld controllers 130, 140, and/or one or more VR controllers (130A-L, R) in the case of the HMD.

### Streaming Issues

When streaming a videogame, one option to reduce latency (and latency variability) is to reduce the amount of data being transmitted.

Consequently a recent approach has been to transmit rendered images at a lower resolution (e.g. 720p or 1080p), and use a neural upscaler at the client to generate a higher resolution image (e.g. 4K) and possibly also extrapolate an additional image (to increase the apparent frame rate).

However this still means there is a delay due to the completion of the rendering pipeline for the image (albeit typically a bit quicker at some stages due to the lower resolution) and also any inherent lag in the network, even if the smaller image size means that it can be transmitted within a target time for that image frame.

It also retains all the issues of compression loss and artefacts that come with encoding, and which can be exacerbated by upscaling.

Accordingly, embodiments of the present description seek an alternative approach.

### Closed Volumes

In embodiments of the present description, a scene (e.g. a virtual region such as inside a house, or in a cave, or in a predetermined tile of an open-world environment) is represented as a closed volume. The volume typically conforms to the range of positions which a virtual camera can occupy when viewing the scene. Hence inside a house it may encompass two floors, and be able to look down from the first floor onto the ground floor, and in effect be similar to the internal volume of the house. Meanwhile in an open environment the volume may be comparatively flat, for example being 100 m×100 m of in-game environment with a height of 4 m (e.g. for an over the shoulder camera viewpoint), or 4 m above the highest point in that part of the environment. It will be appreciated that these examples and dimensions are exemplary only.

Hence more generally the closed volume may be considered to be a bounding box for available viewpoints of a scene within a game. The resulting views themselves may include elements that exist outside the bounding box, e.g. distant mountains visible whilst within the 100×100 m tile of in-game environment, or when looking out of a window of the house.

A general virtual environment can thus be represented as a series of closed volumes, with heights in particular selected according to virtual camera viewpoints available within the environment of the volume.

### Neural Radiance Fields

Each closed volume may then be represented as a respective neural radiance field (NeRF).

A NeRF produces a continuous volumetric scene function in response to training on a (relatively) sparse set of example views. The NeRF is typically a neural network, for example a fully connected deep network, multilayer perceptron, convolutional neural networks, graph neural network or the like. One example is a fully-connected neural network (e.g. and MLP)with an activation layer allowing multiple non-linear activations within the same layer, and a convolutional block on top of the MLP.

In any event, the NeRF is trained using rendered viewpoints for a large number of locations and directions of view of the virtual camera.

Hence typically the inputs are three spatial dimensions (x, y, z) within the closed volume and two orientation directions (e.g. □□□□), and the target is the rendered image of the scene for that location and orientation.

Hence each NeRF may be trained offline on a plurality of renders of viewpoints within its respective closed volume of the game environment. This may require hundreds or thousands of views of the scene.

### Training

Accordingly, a training process can systematically capture renders of the scene from within the closed volume for a suitable sampling of the positions and orientations of the camera available within that closed volume.

However, this is therefore likely to result in a NeRF that gives similar significance (and data budget) to a comparatively unimportant bush or rock as it is to a door to a treasure horde, or a signpost significant to game progress.

Accordingly, training images for the NeRF can be efficiently captured for example, by recording play of the game, together with the camera position and orientation, for example during playtesting of the game.

Playtesting by a number of quality assurance testers, early adopters, or the like, provides a large number of rendered images that-beneficially-are representative of the views that a player will actually be likely to see during game play.

Hence using these images as part of a training set for the NeRF will provide it with more information relevant to the likely gameplay of the user, rather than a blanket coverage of theoretical viewpoints.

Nevertheless, the NeRF should still preferably be capable of rendering positions that appear to be outliers with respect to normal use.

Hence if play records are used, these can be used to/thought of as also creating a heatmap of relevant or typical test images within the closed volume. Subsequently, those parts of the closed volume that do not reach a threshold training coverage in this heatmap can then have images generated for them using the systematic scheme described previously, so that the NeRF is potentially capable of generating valid views not captured in recorded gameplay, whilst still prioritising representation for the most common views.

Optionally, the threshold training coverage levels can be proportional to the distance from heatmap regions generated by playtesting—that is to say, the density of training examples can decrease the further a location is away from locations with a threshold heatmap level from playtesting, so that the likely relevance of locations within the closed volume—and their corresponding training coverage—can be extrapolated or interpolated from the observed relevance of locations in recorded play. The training coverage levels may also be responsive to the heatmap level, so that additional views at a given distance from a regularly used path have a higher training coverage than additional views at a similar distance from a rarely visited location.

Hence training of a respective NeRF may comprise a systematic sweep of the closed volume to generate training samples, or alternatively training samples may be obtained from recorded gameplay, optionally supplemented by a systematic sweep of regions not covered by the recorded gameplay, further optionally as a function of distance from those regions and possibly further the relative ‘heat’ of the heatmap for those regions.

It will be appreciated that whilst the description uses NeRFs for the purposes of explanation, the embodiments herein are not limited to this. Hence more generally where a neural radiance field is referred to herein, this is an example of a ‘neural representation’ that may comprise such a NeRF, or similarly apply to Gaussian splatting, a neural network that compresses 3D information, or any other suitable neural representation of a renderable aspect of the environment.

### Output

With respective NeRFs trained for respective closed volumes of the game environment, it is possible to prompt an image at any anticipated location and viewpoint by inputting that location and viewpoint into the appropriate NeRF, and collecting the generated output image.

### Streaming Method

In effect, embodiments of the present description change the granularity of the streaming process to reduce time dependency. Rather than streaming a new image every 30^{th}, 50^{th}, or 60^{th} of a second to capture incremental changes in viewpoint, instead a NeRF is streamed to the client to provide views through local generation at the client device whilst the user of the client is within a given closed volume of the game environment.

Hence, given a location of a player within the game environment, an appropriate NeRF is transmitted to their client device. Then as the client moves within the closed volume of the game environment represented by that NeRF, images are generated by that NeRF at the client device.

Consequently there is no lag on a frame-by-frame basis as the images are being generated locally, but without the need for original game assets (meshes, textures and the like) or a conventional rendering pipeline and the associated graphics components.

Furthermore, the frame rate of the game at the client device is only limited by the time taken for the NeRF to generate an image; as a result the output may be both high quality and also have a high frame rate (e.g. 60 or 120 Hz) compared to typically lower framerates when the images are streamed. Clearly for client devices with neural network co-processors/accelerators, as are being more frequently found on phones and the like, this may allow for output at a higher quality than is possible or practical when streaming, even when a good connection is available.

It will be appreciated that a given NeRF is larger than an individual image, and will typically take longer to stream to the client-but is not as time critical in terms or avoiding lag for the user.

Accordingly, a NeRF may have associated with it boundary metadata that identifies a border within the closed volume that indicates a certain time to reach the actual boundary of the closed volume.

Hence for example if the closed volume is a 100 m×100 m tile of open environment, the border may be 10 m from the edge, signifying it normally takes 1 second from that border to reach the edge of the closed volume and hence also the capabilities of the current NeRF. Such boundaries may be used to trigger a request for a neighbouring NeRF to be streamed down to the client, so that it is ready if the user crosses the boundary. The boundary can be set for a predetermined typical download time for the relevant adjacent NeRF. Optionally, the client device can compare its own current download speeds with this typical speed to determine if the boundary needs to be extended (e.g. to 15 m) to avoid delays, or could be reduced (e.g. to 5 m) to reduce triggering of unnecessary downloads.

Once a user has crossed into a new closed volume, and passed the corresponding boundary within that volume indicative of the need for the previous NeRF, that previous NeRF can be discarded (or marked as available for deletion so it only discarded if memory constraints require, since statistically it is likely in at least some games that the user may revisit the previous closed volume fairly soon). Similarly, one or more NeRFs may be identified as hub NeRFs and retained locally for the duration of play, or until instructions are receive to discard them, because they represent an area that is visited regularly by the game; this reduces needless repetitions of downloads.

Hence the conventional frame-by-frame closed loop of input>upstream>game engine update>render>encode>downstream>decode>display can be replaced by an alternative loop: location>download NeRF>input>generate view>display, input>generate view>display, input>generate view>display, etc., whilst optionally separately updating the game engine by uploading the inputs in the background, in the case where the user is simply navigating the environment.

When the user is interacting with the environment or performing actions that alter the game in some way, the loop may switch to [Location>download NeRF]>input>upstream>game engine update>downstream the update>generate view>display. The game state update will be of minimal size compared to a normal image.

It will be appreciated that these loops are exemplary only, to illustrate that rendering and downloading of images by the server is no longer essential on a frame-by-frame basis to play the game.

### Interaction With the Generated Environment

At the client, new viewpoints can be generated by the current NeRF in response to location and orientation input prompts. These prompts in turn may be defined by user inputs (e.g. to move and look around) or game events (e.g. the user is falling).

Hence typically the user's input is sent to the server, where the game engine interprets the input, and sends instructions back to the client that updates the position and view to be generated by the NeRF in response to those inputs and game events. This allows the game engine to cause the user to interact with the geometry of the environment, e.g. not being able to walk through walls, and follow the elevation of a path, by preventing unconditional updates of location and constraining them to the environment as would happen during normal local play.

Optionally, alternatively or in addition the geometry of the environment immediately local to the player may be streamed to the client, so that this constraint on motion can be applied locally. This removes the need for a round-trip to the server to update the player's position for each frame. In this case the geometry can be the game mesh, or a simplified version thereof, or voxels defining surfaces (optionally at a lower resolution than the in-game surface), for an immediate vicinity of the user where this may be functionally described as the vicinity the user can navigate to within the time needed to stream down the next section of geometry. As such the amount of geometry streamed can vary in size and cadence to suit network conditions. Such a client-side approach may optionally be used when there is a large lag or ping on the round trip to the server creating lag even when the amount of data to pass between client and server is small.

### Training and Dynamic Content

Typically a NeRF generates a static representation of a scene; in other words, the training images are different renders of the same scene.

By contrast, typically a game is dynamic, with elements of the environment responding to player actions. Hence in some cases the view of a location from one position may show a different version of the location from the view in another position. For example a view outside a room may show the door closed, but from inside it may show the door open.

Optionally these changes can be captured within the NeRF. In some cases the changes are purely positional and so the Nerf may learn any positionally dependent changes in content in much the same way as it learns the positional changes in lighting, perspective, view, and the like.

More generally, again recordings of playtests may be of particular use in this respect as the recorded images will reflect the player's individual or cumulative impact on the environment as they traverse it.

In addition to the environment, there are typically also so-called non-player characters ‘NPCs’ (e.g. friends and enemies) present within the environment, and these often move within the environment in response to a number of factors that are independent of the current camera viewpoint. As such they may not comprise a predictable or learnable component of the environment by the NeRF.

During training on recorded game play, consequently such NPCs may or may not appear in view at the same viewpoints for different playthroughs of the game, or their behaviour may differ for different playthroughs. Hence optionally the playthrough training data may be pruned to omit images where such NPCs are present, or do so if there are other similar views without the NPC present in the recorded playthroughs as an alternative ‘cleaner’ training source. Similarly optionally where an NPC is visible, this may be flagged as a position/orientation at which to generate a training image outside of gameplay, e.g. as part of a systematic sweep.

The above approaches effectively remove the NPCs from the training set (or reduce their influence to a background level) so that the environment generated by the NeRF does not include the NPCs.

### Adding Dynamic Content

Dynamic content such as NPCs can be added to the displayed game by the client in one or more ways.

In a first instance, it is accepted that the environment generated by the NeRF is generally static or non-interactive, and it is used as a background component of the image.

In this case, the graphical representation of the or each NPC for the current image, and any other element that has changed in response to game play, can be generated at the server and streamed to the client; this still typically represents much less data than a full image and so can be received more quickly, thereby reducing lag.

The displayed image is then a superposition of the NPC character and any other received elements onto the NeRF generated image of the environment.

As noted above, it will be appreciated that this approach can be used for other such transitory elements of the scene such as ripples on a river, or background traffic.

Hence in this instance, substantially static elements of the image are generated using a NeRF at the client whilst substantially dynamic elements are generated at the server and streamed. Whilst this mitigates delays because less data is being streamed than for a full image, there may still be scope for further improvement.

Hence in a second instance, a separate NeRF may be trained using an artificially constructed environment separate to the game environment.

Typically this comprises views of one or more NPCs as seen during game play (e.g. game play in the corresponding region of the environment), for example with the or each NPC occupying a respective sub-region of a closed volume, and different locations or viewpoints therein showing different views of the NPC and also different states of the NPC (for example different stages of an animation cycle). One may think of such an environment as a gallery of NPC poses. The appropriate NPC view and pose may then be prompted from the NeRF by input of the appropriate viewing position and optionally orientation. Arranging the viewing positions so that adjacent animation steps have adjacent viewing positions or orientations helps the NeRF to generate its continuous volumetric scene function.

Hence as with the overall environment, the actions of NPCs can also be decoupled from a frame-by-frame streamed graphical update, but including their NeRF or respective NeRF when entering the part of the environment where they are encountered/visible. The respective NeRF can then be used to generate the required NPC view and pose by selection of the appropriate location and optionally orientation with which to prompt the NeRF to access its internal ‘gallery’.

### Variants

The methods and techniques herein are intended to reduce lag caused by the rendering, encoding, and streaming of image data, typically in the context of cloud gaming services or similar.

However, another scenario where images are streamed but lag is important is in virtual reality (VR) head mounted displays such as HMD 120. In this case, any disparity between head motion and viewpoint can result in nausea for some users, and so there is a motivation to reduce this disparity.

In this case the lag is small, and so there is less of an issue in terms of perceived responsiveness to intentional player inputs; rather it relates to tracking voluntary and involuntary movement of the user's head.

Accordingly in an optional variant embodiment of the present description, the techniques herein may be applied to an HMD as the client, so that it can generate some or all of the current image locally at the highest frame rate it can. Optionally it could operate in conjunction with normal streamed image data, and only wholly or partially replace a streamed image if detected motion of the HMD during the period after the viewpoint of the streamed image was fixed exceeds a threshold amount.

In this way the HMD could provide a faithful output of the streamed source, but provide a brief whole or partial replacement when it is estimated that this will assist with nausea reduction.

### SUMMARY

Referring now to FIG. 2, in a summary embodiment of the present description, a method of content streaming comprises the follow steps:

In a first step s210, receiving, for a given camera location in an environment, at a client device a neural representation ‘NR’ (e.g. a neural radiance field, Gaussian splatter, neural network that compresses 3D information, or other suitable neural representation of a renderable aspect of the environment, as described elsewhere herein) corresponding to a region of the environment encompassing that camera location, the NR having been trained to generate images of viewpoints within the corresponding region, as described elsewhere herein. The environment may be a virtual game environment or other virtual simulated environment, but potentially could be a real-world environment such as for example a street-view map.

In a second step s220, repeatedly inputting a current camera location to the NR, whilst the current camera location remains within the region of the environment that the NR corresponds to, causing it to output a corresponding image of the corresponding region at the current camera location, as described elsewhere herein.

And in a third step s230, providing the output image to a display process (for example as an output for a remote or integral display or displays), as described elsewhere herein.

It will be apparent to a person skilled in the art that variations in the above method corresponding to operation of the various embodiments of the apparatus as described and claimed herein are considered within the scope of the present invention, including but not limited to that:
the step of repeatedly inputting a current camera location comprises also inputting a current camera orientation, as described elsewhere herein;
the environment comprises a plurality of regions for each of which a respective NR has been trained, and if the current camera location nears a region boundary, receiving the respective NR for an region adjacent to that boundary, as described elsewhere herein;
a NR is trained on a predetermined sampling of viewpoints within a respective region, as described elsewhere herein;
a NR is trained on images captured during gameplay within a respective region, as described elsewhere herein;
in this case, optionally transient elements within (e.g. NPCs) the environment are omitted from training (e.g. by playing without them, or dropping images comprising them or where they occupy a threshold proportion of the image), as described elsewhere herein;
similarly in this case, optionally the NR is also trained on a predetermined supplemental sampling of viewpoints for parts of the region not trained using images captured during gameplay, as described elsewhere herein;
the client device receives a control input from a user, and obtains an updated current camera location by one selected from the list consisting of updating it at the client device in response to the control, and requesting an update from a remote server, the request comprising information about the control input, and receiving the updated current camera location from the remote server, as described elsewhere herein;
streaming dynamic image elements for the output image to the client device, compositing the output image and the dynamic image elements to produce a composite image, and the step of providing the output image to a display process comprises providing the composite image to a display process, as described elsewhere herein;
receiving at the client device a further NR corresponding to the region, the further NR having been trained on an artificially constructed environment separate to the game environment and comprising views of one or more dynamic image elements in a plurality of states, obtaining a desired dynamic image element in a desired state by inputting to the NR a location corresponding to the views within the artificially constructed environment of the desired dynamic image element in the desired state, causing the NR to generate an image of the desired dynamic image element in the desired state, compositing the output image of the region at the current camera location and the image of the desired dynamic image element in the desired state to produce a composite image, and and the step of providing the output image to a display process comprises providing the composite image to a display process, as described elsewhere herein;
the client device is a head mounted display ‘HMD’, and the method comprises the steps of generating image data using the NR in response to a current user viewpoint, at a generation rate higher than a frame rate of streamed image data, and replacing some or all of the streamed image data if a current user viewpoint has changed by more than a threshold amount from a viewpoint represented by the streamed image data as it is to be displayed to the user, as described elsewhere herein; and
the neural representation is one selected from the list consisting of a neural radiance field (NeRF), a Gaussian splatting, and a neural network that compresses 3D information.

It will be appreciated that the above methods may be carried out on hardware suitably adapted as applicable by software instruction or by the inclusion or substitution of dedicated hardware.

Thus the required adaptation to existing parts of an equivalent device may be implemented in the form of a computer program product comprising processor implementable instructions stored on a non-transitory machine-readable medium such as a floppy disk, optical disk, hard disk, solid state disk, PROM, RAM, flash memory or any combination of these or other storage media, or realised in hardware as an ASIC (application specific integrated circuit) or an FPGA (field programmable gate array) or other configurable circuit suitable to use in adapting the conventional equivalent device. Separately, such a computer program may be transmitted via data signals on a network such as an Ethernet, a wireless network, the Internet, or any combination of these or other networks.

Accordingly, and referring again to FIG. 1 as an example of a client device, then in a summary embodiment of the present description a client device for streaming content (e.g. entertainment device 10), comprises the following.

A receiver (e.g. data port 60, and/or CPU 20) configured (for example by suitable software instruction) to receive, for a given camera location in an environment, a neural representation ‘NR’ corresponding to a region of the environment encompassing that camera location, the neural representation having been trained to generate images of viewpoints within the corresponding region, as described elsewhere herein.

A NR processor (e.g. CPU 20 and/or GPU 30) configured (for example by suitable software instruction) to, whilst the current camera location remains within the region of the environment that the NR corresponds to, repeatedly input a current camera location to the NR, causing it to output a corresponding image of the corresponding region at the current camera location, as described elsewhere herein.

And a graphics processor (e.g. GPU 30 and/or CPU 20) configured (for example by suitable software instruction) to provide the output image to a display process (e.g. via AV port 90, or an integral display, not shown), as described elsewhere herein.

Instances of this summary embodiment implementing the methods and techniques described herein (for example by use of suitable software instruction) are envisaged within the scope of the application, including but not limited to that:
the client device is a head mounted display, and the NR processor is configured generate image data using the NR in response to a current user viewpoint, at a generation rate higher than a frame rate of streamed image data, and the graphics processor is configured to replace some or all of the streamed image data if a current user viewpoint has changed by more than a threshold amount from a viewpoint represented by the streamed image data as it is to be displayed to the user, as described elsewhere herein.

Similarly, referring again to FIG. 1 now as an example of a remote device, then in a summary embodiment of the present description a remote device (e.g. entertainment device 10) for streaming content to a client device, comprises the following.

A receiver (e.g. data port 60, and/or CPU 20) configured (for example by suitable software instruction) to receive from a client device information indicative of a location in an environment, as described elsewhere herein.

A processor (e.g. CPU 20 and/or GPU 30) configured (for example by suitable software instruction) to identify a region of the environment encompassing that location, as described elsewhere herein.

The processor being configured (for example by suitable software instruction) to retrieve one or more neural representations ‘NR’s associated with the identified region, at least one of which has been trained to generate images of viewpoints within the region, as described elsewhere herein.

And a transmitter (e.g. data port 60, and) or CPU 20) configured (for example by suitable software instruction) to stream the or each retrieved NR to the client device, as described elsewhere herein.

Instances of this summary embodiment implementing the methods and techniques described herein (for example by use of suitable software instruction) are similarly envisaged within the scope of the application.

The foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

What is claimed is:

1. A method comprising:
receiving, for a given camera location in an environment and at a client device, a neural representation (NR) corresponding to a region of the environment encompassing the given camera location, the NR having been trained to generate images of viewpoints within the corresponding region;
inputting and repeatedly updating a current camera location to the NR, while the current camera location remains within the region of the environment that the NR corresponds to, causing it to output a corresponding image of the corresponding region at the current camera location; and
providing the output image to a display process.

2. The method of claim 1, further comprising:
repeatedly inputting a current camera location, the current camera location comprising an input of a current camera orientation.

3. The method of claim 1, wherein the environment comprises a plurality of regions, wherein a respective trained NR is associated with each region of the plurality of regions, and the method further comprising:
receiving the respective trained NR for a region adjacent to a boundary if a current camera location nears a region boundary.

4. The method of claim 3, wherein the respective trained NR is trained on a predetermined sampling of viewpoints within a respective region.

5. The method of claim 3, wherein the respective trained NR is trained on images captured during gameplay within a respective region.

6. The method of claim 3, wherein transient elements within the environment are omitted from generating the respective trained NR.

7. The method of claim 3, wherein the respective trained NR is trained on a predetermined supplemental sampling of viewpoints for parts of the region not trained using images captured during gameplay.

8. The method of claim 1, further comprising:
receiving a control input; and
obtaining an updated current camera location by:
updating the current camera location at the client device in response to the control input;
requesting an update from a remote server, the request comprising information about the control input, and receiving the updated current camera location from the remote server; or
combination thereof.

9. The method of claim 1, further comprising:
streaming dynamic image elements for the output image to the client device; and
compositing the output image and the dynamic image elements to produce a composite image, and wherein providing the output image to a display process comprises providing the composite image to a display process.

10. The method of claim 1, further comprising:
receiving at the client device a further NR corresponding to the region, the further NR having been trained on an artificially constructed environment separate to a game environment comprising views of one or more dynamic image elements in one or more states;
obtaining a desired dynamic image element in a desired state by inputting to the NR a location corresponding to the views within the artificially constructed environment of the desired dynamic image element in the desired state, causing the NR to generate an image of the desired dynamic image element in the desired state;
compositing the output image of the region at the current camera location and the image of the desired dynamic image element in the desired state to produce a composite image; and
providing the output image to a display process comprises providing the composite image to a display process.

11. The method of claim 1, further comprising:
identifying when the client device is a head mounted display ‘HMD’;
generating image data using the NR in response to a current user viewpoint, at a generation rate higher than a frame rate of streamed image data; and
replacing some or all of the streamed image data if a current user viewpoint has changed by more than a threshold amount from a viewpoint represented by the streamed image data as it is to be displayed to the user.

12. The method of claim 1, further comprising:
selecting the neural representation identified as a selection of a single neural representation from a set comprising:
a neural radiance field;
a Gaussian splatting; and
a neural network that compresses 3D information.

13. One or more non-transitory computer-readable media comprising instructions that, when executed by one or more processors, cause the one or more processors to perform operations comprising:
receiving, for a given camera location in an environment and at a client device, a neural representation (NR) corresponding to a region of the environment encompassing the given camera location, the NR having been trained to generate images of viewpoints within the corresponding region;
inputting and repeatedly updating a current camera location to the NR, while the current camera location remains within the region of the environment that the NR corresponds to, causing it to output a corresponding image of the corresponding region at the current camera location; and
providing the output image to a display process.

14. The non-transitory computer-readable medium of claim 13, the operations further comprising:
repeatedly inputting a current camera location, the current camera location comprising an input of a current camera orientation.

15. The non-transitory computer-readable medium of claim 13, wherein the environment comprises a plurality of regions, wherein a respective trained NR is associated with each region of the plurality of regions, and the operations further comprising:
receiving the respective trained NR for a region adjacent to a boundary if a current camera location nears a region boundary.

16. The non-transitory computer-readable medium of claim 15, wherein the respective trained NR is trained on a predetermined sampling of viewpoints within a respective region.

17. The non-transitory computer-readable medium of claim 15, wherein the respective trained NR is trained on images captured during gameplay within a respective region.

18. The non-transitory computer-readable medium of claim 15, wherein transient elements within the environment are omitted from generating the respective trained NR.

19. The non-transitory computer-readable medium of claim 15, wherein the respective trained NR is trained on a predetermined supplemental sampling of viewpoints for parts of the region not trained using images captured during gameplay.

20. A system comprising:
one or more processors; and
one or more computer-readable media storing instructions that, when executed by the one or more processors, cause the system to perform operations comprising:
receiving, for a given camera location in an environment and at a client device, a neural representation (NR) corresponding to a region of the environment encompassing the given camera location, the NR having been trained to generate images of viewpoints within the corresponding region;
inputting and repeatedly updating a current camera location to the NR, while the current camera location remains within the region of the environment that the NR corresponds to, causing it to output a corresponding image of the corresponding region at the current camera location; and
providing the output image to a display process.
